(19) United States
(12) Patent Application Publication
(10) Pub. No.: US 2004/0205541 A1
(43) Pub. Date: Oct. 14, 2004

(54) Web browser with annotation capability

(76) Inventor: Mario D'Amico, Laval (CA)

Correspondence Address: Ralph A. Dowell, DOWELL & DOWELL, P.C., Suite 309, 1215 Jefferson Davis Highway, Arlington, VA, 22202, US

(21) Appl. No.: 09/922,745

(22) Filed: Aug. 7, 2001

(51) Int. Cl. G06F 15/00

(52) U.S. Cl. 715/512; 715/501.1

(57) ABSTRACT

A data file suitable for processing by a web browser executing on a computer having a display. The file includes a first set of data causing the browser to render on the display a fixed representation of a document. The file also has a second set of data representative of DHTML code, the DHTML code donating to the web browser an annotation functionality permitting a user to annotate the fixed representation of the document.

### FIELD OF THE INVENTION

The present invention relates to a web browser with annotation capability.

### BACKGROUND OF THE INVENTION

Currently, e-mail is the dominant vehicle used in time shifted (as opposed to on-line) document collaboration between multiple parties using the Internet as the transport. The reason e-mail is being used is simply that it has evolved from its use internally in organizations to its use across organizations (the network has simply been extended and the tool has remained). However, the use of e-mail as a tool for collaboration between parties has pitfalls:

1. The volume of e-mail makes it impossible to effectively manage content. The communication thread and the association to specific subject matter become very obscure or non-existent. Too many copies of the document (subject matter) make it difficult to achieve a common conclusion based on input from multiple parties. Collaboration is accomplished via the exchange and modification of documents and this in the format of the production software (i.e. word processor), creating numerous compatibility and version issues.

2. The e-mail repository is personal meaning the documents cannot easily be shared, without extensive transport, thereby once again creating versioning issues.

3. Versioning and document comparison issues result because of exchange of documents via the production tool, (i.e. the word processors).

Another approach to achieving on-line collaboration is based on the web technology. The document on which users collaborate is made available on a network server. Remote access to the document is possible through a web browser at a remotely located client. The server sends a file containing the document expressed in Hyper Text Markup Language (HTML) to the web browser that renders the document on the display such that the user can see it.

The use of a web browser to render the document largely resolves the compatibility issues arising when the document is distributed in the format of the production software. The HTML language in which the document is sent to the web browser is a standard and can be interpreted by any browser, independent of the browser vendor.

Currently available web browsers do not provide effective annotation tools. While a user can view a document, the process for adding comments to the document and making those comments available to the author or to other users is inexistent or cumbersome at best. To alleviate this difficulty, it has been suggested to provide extensions to the basic browser such as to allow a reasonable level of annotation functionality. These extensions include the use of new HTML annotations tags, the use of Extended Markup Language (XML), or creating sophisticated add-ins such as plug-ins or java applets.

Although the add-ins approach can provide effective annotation functionality, it raises compatibility issues since all users in the group of collaborators must have compatible add-ins.

Against this background, it clearly appears that a need exists in the industry to develop annotation tools for a web browser without the need of add-ins.

### SUMMARY OF THE INVENTION

In a broad aspect, the invention provides a file suitable for processing by a web browser executing on a computer having a display. The file includes a first set of data causing the browser to render on the display a fixed representation of a document by implementing a document object model. The document object model has one or more methods to manipulate HTML. The file also has a second set of data donating to the web browser an annotation functionality permitting a user to annotate the fixed representation of the document. The annotation is implemented by invocation of one or more methods of the document object model that manipulates HTML.

In this specification, “manipulating HTML” means inserting, removing or modifying HTML.

This approach donates to the web browser effective annotation functionality without the necessity of traditional add-ins. Since the annotation is made on a fixed representation of the document, the annotation data can be positively located in the document, with little or no ambiguity.

In this specification the expression “file” should be interpreted as a collection of information containing user data, such as fixed representation of the document, program data, or any other information used by a program or necessary for the execution of a program, without limitation on the particular format in which the collection information is expressed, transmitted or stored.

In this specification, the expression “fixed representation of a document” is a representation where the position of the various elements of the image, containing text, non-text information or both, one with respect to another, stay fixed, independently of the particular web browser on which the representation is rendered. For instance, in a multi-page document, each page will contain exactly the same text and specific attributes such as footers, headers, indents, text wrapping around images and image absolute positioning will be the same independently of the browser rendering the page. One example of a fixed representation is a representation of a document in printed format.

A fixed representation of a document can be electronically expressed, transmitted or stored in formats such as Graphics Interchange Format (GIF), Joint Photographic Experts Group (JPEG) format, Tagged Image File Format (TIFF) and Bitmap (BMP) format, among others. This list should not be considered exhaustive as other possibilities exist without departing from the spirit of the invention.

In a specific and non-limiting example of implementation, the data file is transmitted from a server to a client machine on which the web browser is executing. The file is stored in a computer readable storage medium in the client machine, such as a rigid drive storage unit or the Random Access Memory of the machine. The file is loaded by the web browser. The web browser renders the fixed representation of the document. The second set of data in the file is interpreted to create at least one annotation tool that the user can invoke to annotate the fixed representation of the document. The annotation tool can be in the form of a highlight tool, a pen tool and a notes tool, among others. The tool is accessed by pressing a button on a toolbar, by pressing a key on the keyboard, or any other suitable invocation procedure.

The operation of the annotation tool creates annotation data. The annotation data is HTML data, appended to the original data file in the form of a layer to the fixed representation of the document. The annotation data includes an annotation image element and coordinates information. The annotation image element includes the information added by the user. For instance, in the case of the pen tool, the user circles words, phrases or paragraphs to highlight them. The annotation image element is the trace of the pen. The annotation image element can be stored in the original file in formats such as Graphics Interchange Format (GIF), Joint Photographic Experts Group (JPEG) format, Tagged Image File Format (TIFF) and Bitmap (BMP) format, among others.

The coordinated information includes data specifying the position of the annotation image element in the fixed representation of the document. This allows to properly registering the annotation image element with a component of the document that is being annotated.

After the annotation procedure is completed, the user has the option of returning the original data file to which has been appended the annotation data to the source such that it can be stored there for future reference.

The invention also provides a method for annotating a document, including processing a file by a web browser executing on a computer having a display. The file includes a first set of data causing the browser to render on the display a fixed representation of a document by implementing a document object model that has at least one method for manipulating HTML. The file also includes a second set of data donating to the web browser an annotation functionality permitting a user to annotate the fixed representation of the document by invocation of at least one method of the document object model that manipulates HTML.

The invention further provides a signal transmission medium containing a data signal representing a file suitable for processing by a web browser executing on a computer having a display. The file has a first set of data causing the browser to render on the display a fixed representation of a document by implementing a document object model that has at least one method for manipulating HTML. The file also includes a second set of data donating to the web browser an annotation functionality permitting a user to annotate the fixed representation of the document by manipulating HTML by invocation of at least one method of the document object model.

### BRIEF DESCRIPTION OF THE DRAWINGS

A detailed description of examples of implementation of the present invention is provided herein below with reference to the following drawings, in which:

FIG. 1 is a diagram of a network based collaborative system where a plurality of workstations communicate with a server on which are stored files to be accessed by the individual workstations;

FIG. 2 is a block diagram of a workstation shown in FIG. 1;

FIG. 3 illustrates the structure of a file stored on the server and that can be accessed by the workstations;

FIG. 4 is a functional block diagram of a web browser executing on a workstation;

FIG. 5 is an example of a rendering on the display of the workstation of FIG. 4 of a fixed representation of a document;

FIG. 6 illustrates the image on the display after the user has applied an annotation;

FIG. 7 illustrates a conceptual representation of the annotation made in FIG. 6, in the form of a layer to the fixed representation of the document; and

FIG. 8 illustrates the structure of the file shown in FIG. 3, to which has been appended annotation data.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

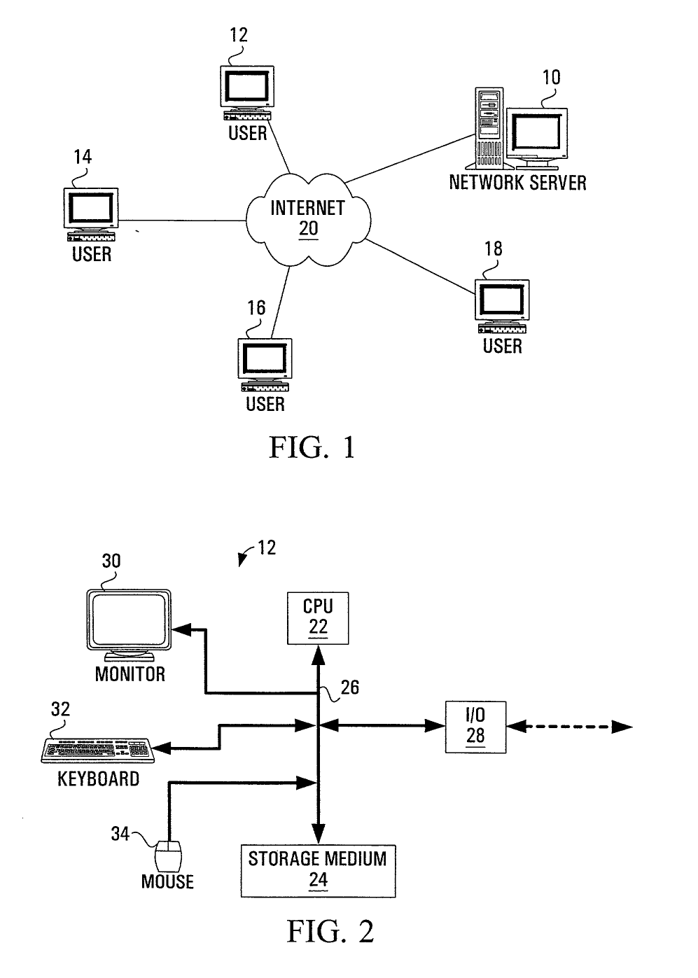

FIG. 1 shows a simplified diagram of a system of interconnected computers over which users can collaborate. The system includes a server 10 that connects to individual workstations 12, 14, 16 and 18 over a network 20 such as the Internet. The server 10 holds resources that can be accessed through the individual workstations 12, 14, 16 and 18.

FIG. 2 is a block diagram of the workstation 12. The structure and operation of the other workstations 14, 16 and 18 are identical and will not be described in detail here.

The workstation 12 includes a Central Processing Unit (CPU) 22 connected to a storage medium 24 over a data bus 26. Although the storage medium 24 is shown as a single block, it may include a plurality of separate components, such as a floppy disk drive, a fixed disk and Random Access Memory (RAM), among others. The workstation also includes an Input/Output interface 28 that connects to the data bus 26. The I/O 28 is the entity through which the workstation 12 communicates with the external world. For instance, data sent from or received by the workstation 12, during a communication session with the server 10 or any other workstation 14, 16 and 18 transits through the I/O 28.

A monitor 30, connecting to the data bus 26, displays information to the user. The user can enter commands through a keyboard 32 and a pointing device in the form of a mouse 34.

During collaboration, the user at the workstation 12 connects with the server 10 to access a file residing on the server 10. The data exchange is made by using a protocol such as the Transport Control Protocol/Internet Protocol (TCP/IP). The user communicates with the server 10 through a web browser executing on the workstation 12. The web browser is a program element including individual instructions and residing in the storage medium 24. The individual instructions are executed by the CPU 22 to implement the browser functionality. A functional block diagram of the web browser is shown at FIG. 4. The web browser 36 includes a Graphical User Interface 38 and a central manager 40 that manages communications with external entities, such as the server 10, performs the necessary operations to allow the user to view through the GUI 38 Hypertext Markup Language (HTML) documents, etc. It is not deemed necessary here to discuss in detail the structure and operation of the GUI 38 and the manager 40, since these components are off the shelf items.

When the communication session with the server 10 is established, the user identifies through the web browser 36 the file to be accessed. The server 10 sends the file to the workstation 12 over the signal transmission medium linking both entities. The file is encoded according to the selected protocol, such as TCP/IP and forwarded to the workstation.

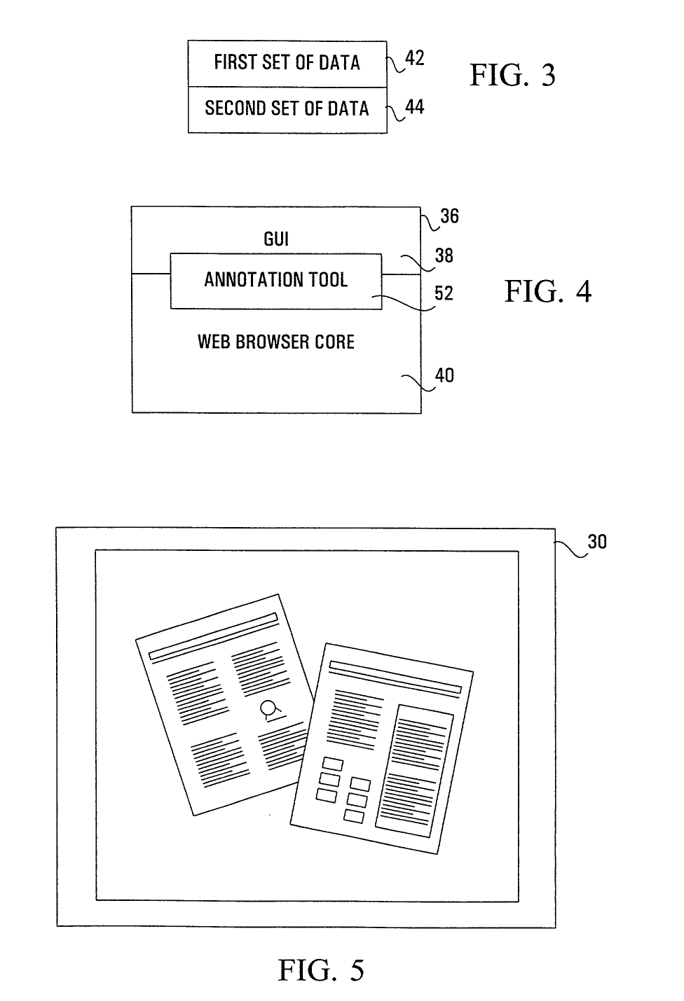

FIG. 3 shows the data structure of the file. The file has two components, namely a first set of data 42 and a second set of data 44. The first set of data is user information and contains a fixed representation of a document. The document may be a single page document or a multiple page document. In one specific example, the fixed representation is a representation of the document in printed form. This representation may be expressed by encoding the image of the printed document in a format such as Graphics Interchange Format (GIF), Joint Photographic Experts Group (JPEG) format, Tagged Image File Format (TIFF) and Bitmap (BMP) format, among others. The second set of data is program data that allows the web browser to implement an annotation functionality.

When the data representing the file is received by the workstation 12 it is placed in the storage medium 24 and then loaded in the web browser 36. The web browser 36 interprets the first set of data and renders the fixed representation of the document by implementing a document object model. Assume that the document is a single page document and that it is a non-text document, consisting of the image of two sheets of paper. The image displayed by the monitor is shown at FIG. 5.

The web browser 36 also interprets the second set of data, which is program data. The program data implements in the web browser 36 at least one annotation tool 52, shown at FIG. 4. The annotation tool 42 is made available to the user through the GUI 38. Possible examples of this implementation include creating on the existing toolbar a series of buttons (not shown), each associated with a certain annotation tools that are independently selectable. Examples of annotation tools include a pen tool, a notes tool and a highlight tool, among others.

When a user selects an annotation tool by clicking on the button associated with that tool, it invokes a method of the document object model to manipulate HTML. Examples of such methods in Dynamic Hypertext Markup Language (DHTML) include:

1. ApendChild method—Appends an element as a child to an object;

12. Add method—Adds an element to the:

a. areas.asp—areas;

b. controlRange.asp—Control Range;

c. options.asp—options collections;

3. AppendData method—Adds a new character string to the end of the object;

4. CloneNode method—Copies a reference to the object from the document hierarchy;

5. CreateCaption method—Creates a caption;

6. CreateComment method—Creates a comment;

7. CreateControlRange method—Creates a control range collection of nontext elements;

8. CreateElement method—Creates an instance of the element for the specified tag;

9. CreateTextNode method—Creates a text string from the specified value;

10. CreateTextRange method—Creates a text range object for the element;

11. DeleteCell method—Remove a specified cell;

12. DeleteData method—Removes a specified range of characters from the object;

13. Duplicate method—Returns a duplicate of the text range;

14. GetAdjacentText method—Returns the adjacent text string;

15. InsertAdjacentElement method—Inserts an element at the specified location;

16. InstertsAdjacentHTML method—Inserts the given HTML text into the element at the location;

17. Write method—Writes one or more HTML expressions to a document in the specified window;

18. X method—Sets or retrieves the x-coordinate, in pixels, of the mouse pointer's position relative to the parent element;

19. Y method—Sets or retrieves the y-coordinate, in pixels, of the mouse pointer's position relative to the parent element;

It is expressly noted that the above methods are merely examples. Other methods can be employed without departing from the invention.

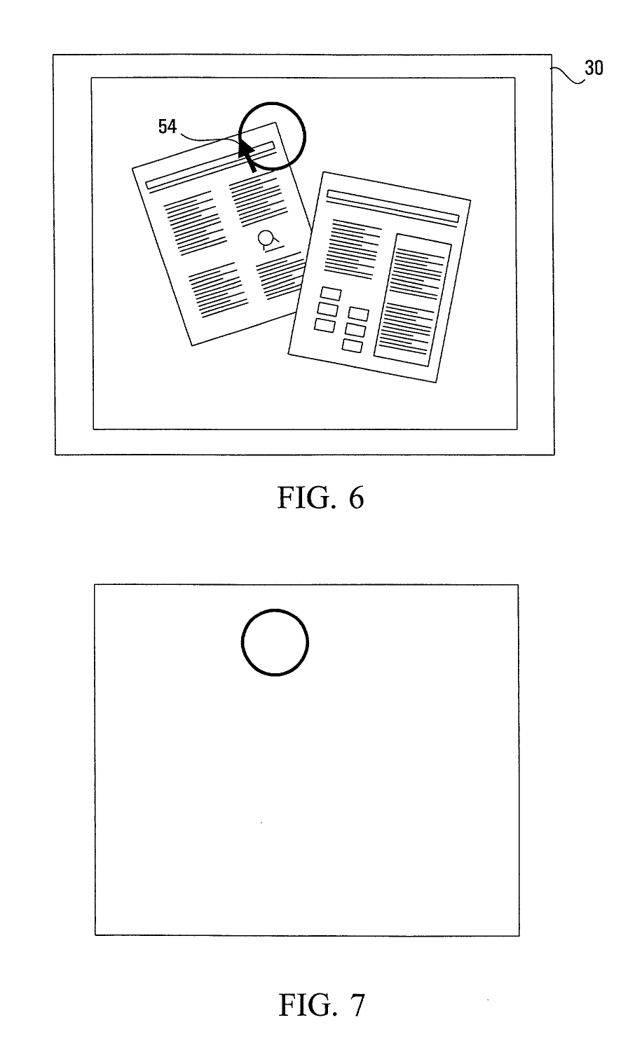

A detailed example is shown in FIG. 6. In this example, the pen annotation tool is selected. When the user is ready to make the annotation, a button on the mouse 34 is depressed. The button click invokes a method of the document object model that starts generating HTML annotation data. The annotation data includes two components. The first component is an annotation image element, which describes the trace followed by the mouse pointer 54 on the monitor 30. In one example, the annotation image element is expressed in a format such as Graphics Interchange Format (GIF), Joint Photographic Experts Group (JPEG) format, Tagged Image File Format (TIFF) and Bitmap (BMP) format, among others. The second component of the annotation data is to coordinate information specifying the position of the annotation image element in the fixed representation of the document. The coordinates information can be the coordinates of the mouse pointer 54 when the annotation started.

The annotation tool 52 generates the annotation data as HTML language, which is appended to the original file and forms a layer to the fixed representation of the document. This layer is conceptually shown at FIG. 7. The annotation image element is separate from the fixed representation of the document but it can be superposed to form a compound image to show where the annotations are made.

In light of the fact that the document is expressed in a fixed representation format, the registration between the annotation image element in the layer and the component of the document being annotated can be accurately maintained. When the file including the annotation data is rendered on a browser different than the browser used to create the annotation, this registration will be maintained, thus the annotation will be in its proper position.

The annotation data can also include additional information such as the identity of the author that has made the annotation, a date and time stamp as well as any other suitable information. This additional information is expressed in HTML language as well.

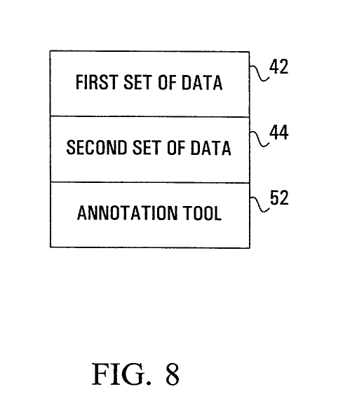

The annotation data is appended to the original file as shown at FIG. 8. As mentioned previously, it is maintained in the form of a layer separate from the original fixed representation of the document.

For the purpose of this specification, it is not deemed necessary to provide a detailed description of the notion of layers, since storing, creating or manipulating images as layers is something well known in the art.

Although various embodiments have been illustrated, this was for the purpose of describing, but not limiting, the invention. Various modifications will become apparent to those skilled in the art and are within the scope of this invention, which is defined more particularly by the attached claims.

1. A computer readable storage medium containing a file suitable for processing by a web browser executing on a computer having a display, said file comprising:
a. a first set of data causing the browser to render on the display a fixed representation of a document by implementing a document object model that has at least one method to manipulate HTML;
b. a second set of data which causes the web browser to make available to the user at least one annotation tool donating to the web browser an annotation functionality, said annotation tool permitting a user to annotate the fixed representation of the document by invocation of one or more methods of the document object model that manipulate HTML.

2. A computer readable storage medium as defined in claim 1, wherein use of the tool for annotating the fixed representation of the document invokes at least one method of the object model for generating HTML data.

3. A computer readable storage medium as defined in claim 2, wherein said second set of data causes the web browser to make available to the user a plurality of annotation tools, said annotation tools being independently selectable by the user for annotating the fixed representation of the document.

4. A computer readable storage medium as defined in claim 3, wherein the plurality of annotation tools include a pen tool, a highlight tool and a notes tool.

5. A computer readable storage medium as defined in claim 1, wherein use of the annotation tool invokes one or more methods of the object model that manipulate HTML to generate HTML annotation data constituting a layer to the fixed representation of the document.

6. A computer readable storage medium as defined in claim 5, wherein the HTML annotation data includes an annotation image element and coordinates information specifying the position of the annotation image element in the fixed representation of the document.

7. A computer readable storage medium as defined in claim 6, wherein the HTML annotation data includes identity data identifying an author of the annotation data.

8. A computer readable storage medium as defined in claim 7, wherein the HTML annotation data includes a data stamp.

9. A computer readable storage medium as defined in claim 8, wherein the HTML annotation data includes a time stamp.

10. A computer readable storage element as defined in claim 1, wherein the document includes multiple pages.

11. A computer readable storage element as defined in claim 1, wherein the fixed representation of the document is a representation of the document in printed form.

12. A computer readable storage element as defined in claim 1, wherein the first set of data includes data in a format selected in the group consisting of GIF, JPEG, TIFF representing the document in printed form.

13. A method for annotating a document, comprising:
a. processing a file by a web browser executing on a computer having a display, the web browser implementing an object model having at least one method for manipulating HTML, the file including:
i. a first set of data causing the browser to render on the display a fixed representation of a document;
ii. a second set of data donating to the web browser an annotation functionality permitting a user to annotate the fixed representation of the document by manipulating HTML through at least one method of the object model.
b. using the annotation functionality to generate HTML annotation data through the method of the object model, the HTML annotation data constituting a layer to the fixed representation of the document;
c. appending the HTML annotation data to the file.

14. A method as defined in claim 13, including establishing a communication with a remote server and forwarding to the remote server the file to which is appended the HTML annotation data.

15. A signal transmission medium containing a data signal representing a file suitable for processing by a web browser executing on a computer having a display, said file comprising:
a. a first set of data causing the browser to render on the display a fixed representation of a document by implementing a document object model that has at least one method to manipulate HTML;
b. a second set of data which causes the web browser to make available to the user at least one annotation tool donating to the web browser an annotation functionality, said annotation tool permitting a user to annotate the fixed representation of the document by invocation of one or more methods of the document object model that manipulate HTML.
